(19) United States
(12) Patent Application Publication
(10) Pub. No.: US 2007/0144434 A1
(43) Pub. Date: Jun. 28, 2007

(54) Rod cradle for a film, coating or sealing rod

(75) Inventors: Ari-Pekka Kautto, Jyskä (FI); Sami Kuparinen, Jyväskylä (FI); Timo Lintula, Keuruu (FI)

Correspondence Address: STIENNON & STIENNON, 612 W. MAIN ST., SUITE 201, P.O. BOX 1667, MADISON, WI, 53701-1667, US

(73) Assignee: METSO PAPER, INC., Helsinki (FI)

(21) Appl. No.: 10/596,665

(22) PCT Filed: Dec. 16, 2004
(86) PCT No.: PCT/FI04/50189

§ 371 Date: Jun. 20, 2006

(30) Foreign Application Priority Data
Dec. 22, 2003 (FI) 20035248

(51) Int. Cl. B05C 11/00; B05C 1/08

(52) U.S. Cl. 118/506; 118/258

(57) ABSTRACT

A cradle for a film, coating, or sealing rod has a profile (10) that includes a base part (11), a rod groove (16), and a body part (14) between them. The rod groove (16) is arranged to receive the rod (12) between lips (20, 20′) edging the rod groove (16). The circumference lying against the rod (12) is formed at least partly of a slider piece (22), which is an insert-molded part of the profile (10), and which is of a material other than the material of the base part (11) and the body part (14).

The present invention relates to a cradle for a film, coating, or sealing rod, in which the rod cradle has a profile that includes a base part, a rod groove, and a body part between them, and in which the rod groove is arranged to receive the rod between lips edging the rod groove, and in which the circumference lying against the rod is formed at least partly of a slider piece of a material other than the material of the base part and the body part. Rod cradles are used in surface-sizing and coating devices. Usually the profile includes at least one liquid groove formed on the bottom of the rod groove.

Usually, the rod cradle is machined, moulded, or extruded from a single material. A compromise must then be made between the material requirements.

Finnish patent 111477 (WO00/63494) discloses a coating device for a paper machine, in which the coating cradle is in two parts. The two-part construction permits the rod groove to be made from a material better suited to the operation of the rod, when a flexible material of sufficient strength is used in the body and base parts. However, the solution disclosed is a complex totality. As such, the problems referred to in the patent are still relevant The wear resistance of the rod cradle will not be satisfactory, if the material must be selected as a compromise with the requirements of the base and body parts. If the rod is installed in a very hard cradle, both the rod and the cradle are in danger of breaking.

In general, widely differing technical demands are placed on the rod cradle, such as
good wear resistance
easy installation of the rod
good slip properties when dry and when lubricated with water, paste, or size
good non-dirtying/release properties
attenuation of vibration
good chemical resistance in the prevailing environmental conditions

Application publications DE 10045515 and WO 03/078077 disclose the creation of a separate rod-groove component. A rod bed consisting of a slot-like piece, which has, in addition to the rod groove, a water groove for water lubrication, is manufactured from a material with better wear resistance. The body part has a recess of corresponding size for this rod bed, to which the rod bed is locked mechanically. Such a solution is obviously expensive to manufacture, because the rod bed must be made in a completely separate work stage while the recess it requires is machined in its own work stage.

Wear resistance can be improved by surfacing, as is disclosed in PCT publication WO 00/58555. However, the thickness of the surfacing remains so small as to make the result unsatisfactory.

The present invention is intended to create a simpler rod-cradle construction than previously, in which the problems referred to are solved and the desired properties are achieved at least satisfactorily. The characteristic features of the invention are stated in the accompanying Claims. According to the invention, a hard wear-resistant slider piece is insert moulded in the profile of the rod cradle, and is bounded on the bottom of the rod groove by part of the circumference lying against the rod. In a second embodiment, the insertion casting includes the entire rod groove, together with the liquid channel. In a third embodiment, the slider piece is formed with the aid of the non-homogeneity of the profile. On the bottom of the rod groove, the compound at the location forming the sliding surface is densified or rarefied, thus increasing the local hardness and wear resistance.

Other embodiments and advantages of the invention are described in connection with the later examples of applications. The slider piece is generally harder than the body of the cradle, which is usually made form polyurethane. The slider piece is not made by extrusion from polyurethane, instead it can be of sintered thermoplastic or thermoset plastic, or moulded from hard polyurethane by insert moulding.

In the following, the invention is examined with the aid of examples, which are shown in the accompanying figures:

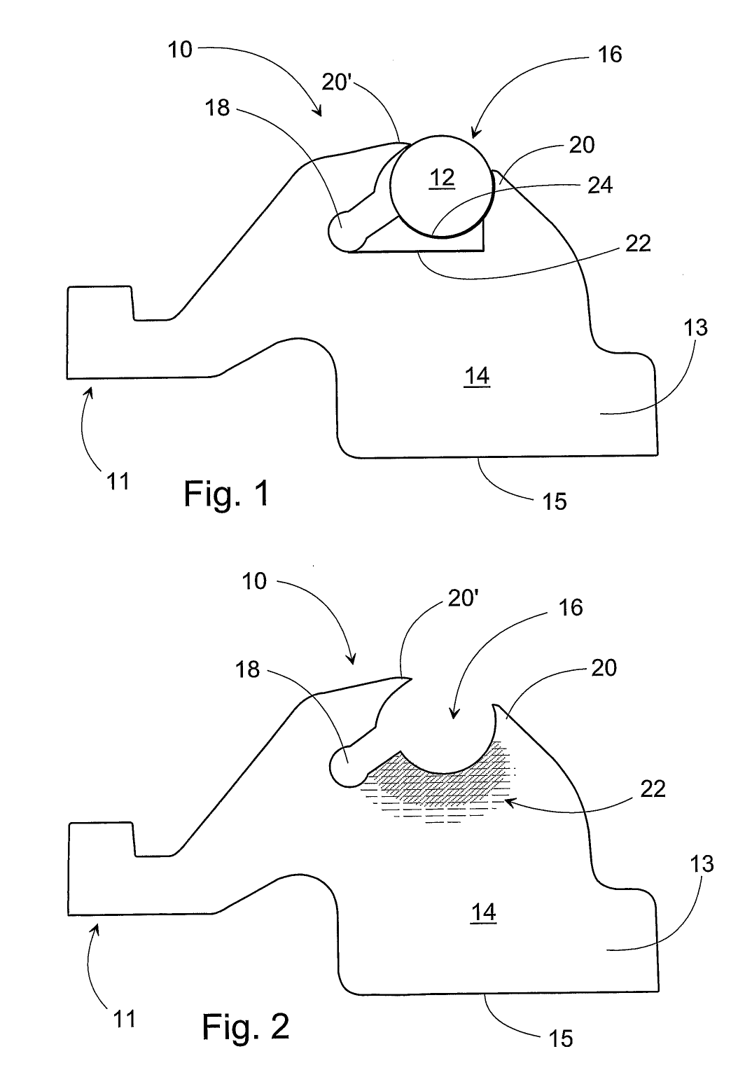

FIG. 1 shows a rod cradle equipped with an insertion-moulded slider piece,

FIG. 2 shows a rod cradle equipped with a sliding surface based on non-homogeneity,

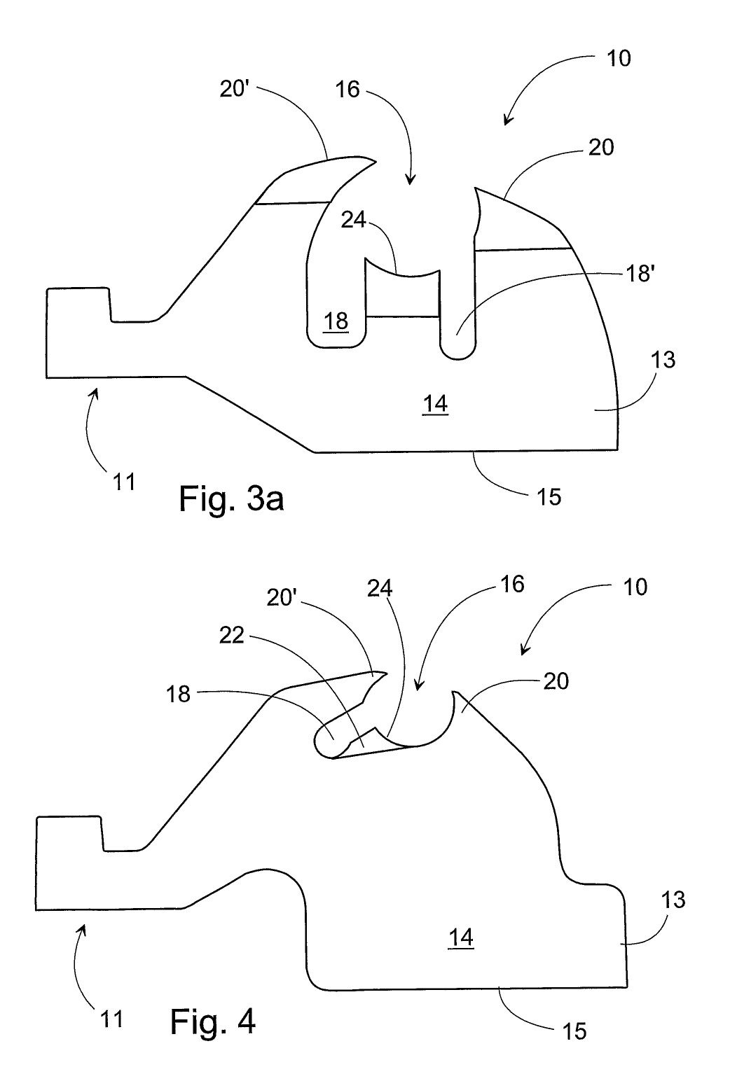

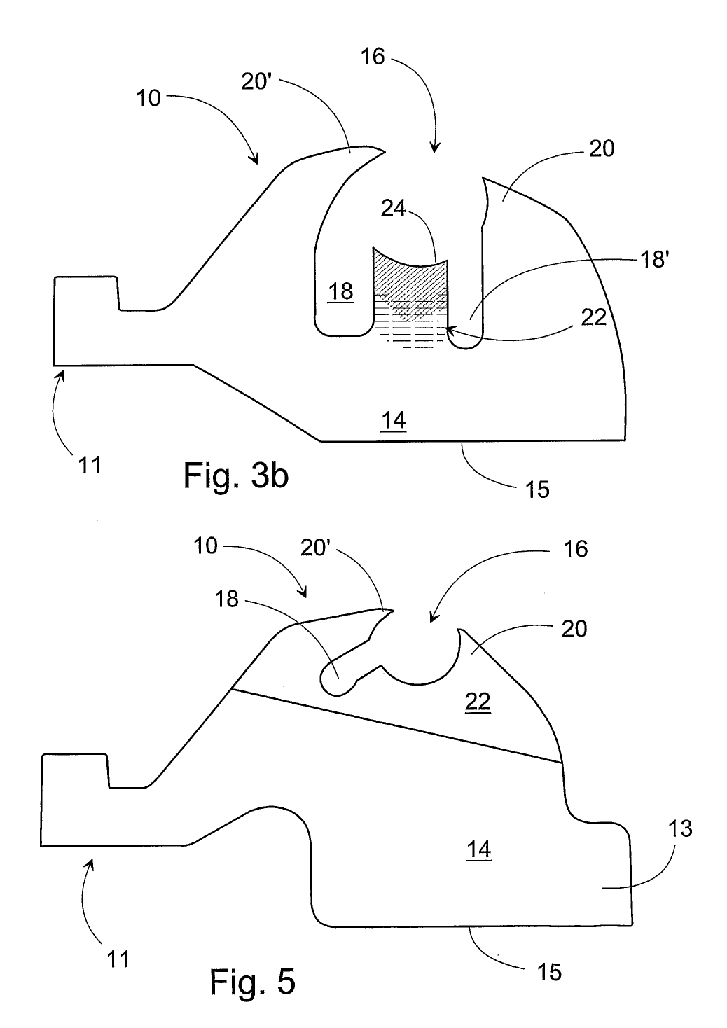

FIG. 3a shows a rod cradle equipped with an insertion-moulded slider piece and lip pieces,

FIG. 3b shows an adaptation of the rod cradle of FIG. 3a,

FIG. 4 shows an adaptation of the rod cradle of FIG. 1,

FIG. 5 shows a rod cradle equipped with an insertion-moulded rod-groove part.

The slider cradles of FIGS. 1-5 are intended for known types of coating machines, which are used in paper and board machines. In all of the figures, the same reference numbers are used for components that are functionally similar. Thus, the reference number 10 shows the actual cradle profile while its main components are a base part 11, a body part 14, a loading surface 15, a rod groove 16, its lips 20 and 20′, and a liquid groove 18.

There is a widening 13 in the cradle profile of FIG. 1, in order to widen the loading surface 15 for two loading hoses.

In terms of the present invention, the essential feature is the slider piece 22, formed on the bottom of the road groove 16, the sliding surface 24 of which forms only a part of the sliding surface lying against the rod in the rod groove. The slider piece 22 is formed optimally in the area in which wear is otherwise greatest. The lips 20 and 20′ can be formed from a flexible base material, so that there is no need to compromise in the seal. In this case, a coating rod 12 is set in the rod groove.

In FIG. 2, there is a variation of the rod cradle of FIG. 1. The slider piece of the profile is formed with the aid of non-homogeneity in such a way that, at the location of the slider piece of FIG. 1, there is a harder and more wear-resistant area forming through the selection of the compound material.

The manufacture of the rod cradle of FIG. 1 takes place as two consecutive mouldings, in such a way that the rod cradle is moulded in an up-and-down position relative to FIG. 1, so that in the first stage the slider piece 22 is moulded on the bottom of the mould with the aid of an additional mould, after which the additional mould is removed, so that some other part of the profile of the rod cradle can be moulded. The mouldings are joined permanently to each other.

The cradle profile of FIG. 2 can be moulded, for example, in such a way that the lower part of the rod cradle is moulded in an inverted state relative to the figure, by filling the mould half-way, after which a bead is laid at a selected point using a polymer compound that spreads to a limit extent in semi-rigid moulding, in a manner based on specific gravity, a chemical reaction, mixing, or some other spreading mechanism. The desired non-homogeneity of the profile and the desired hardness on the bottom of the rod groove can be achieved using the correct polymer and compound selection.

FIG. 3a shows an adaptation of the rod cradle of FIG. 1. In this model, there is no additional flange component, but there is a second water groove 18′. In this model, there are particularly lips 20 and 20′ which are insertion-moulded parts and which bound the rod groove 16. In this way, the wearing sliding surface and the sealing sliding surfaces can be formed optimally, independently of the properties of the base part and the body.

FIG. 3b shows a further adaptation of the cradle of FIG. 3a. The ridge between the liquid grooves 18, 18′ is mixed, in order to optimize the properties of the sliding surface. In this case, the lips 20, 201 are of the base material.

FIG. 4 shows an adaptation of the cradle profile of FIG. 1. In this case, the slider piece 22 is quite small, normally covering the cradle part that wears most in the rod groove 16.

FIG. 5 shows an embodiment that differs completely from that described above, including a attached part 22, which includes both the rod groove 16 and the liquid groove 18 in their entirety. Though in this solution the whole sliding surface is of the same material, the solution nevertheless provides an opportunity to optimize the wearing surface, compared to the material of the base part 16 and the body part 14.

### ADVANTAGES OF THE INVENTION

By manufacturing the cradle from two or more materials, the good properties of each material can be exploited.
The body of the cradle can be easily manufactured from mass-produced polyurethane, which is elastic and thus permits easy installation of the rod while also allows good sealing of the liquid groove. Polyurethane is environmentally durable and attenuates vibration.
The main sliding surface of the cradle can be manufactured from a low-friction material, such as UHMW-PE, HDPE, or fluoro-plastic.
The lips of the cradle can be manufactured alternatively from polyurethane with a good sealing property, or from low-friction hard polyurethane, by insert moulding.

1-7. (canceled)

8. A rod cradle for a film, coating, or sealing rod, comprising:
portions of the rod cradle forming a base part, portions of the rod cradle defining a rod groove, and portions of the rod cradle forming a body part which is between the base part and the rod groove;
wherein the base part and the body part are formed of a first material;
wherein the portions defining a rod groove include circumference portions edging the rod groove, the circumference portions including portions forming lips, the rod groove being arranged to receive a rod between said lips, and wherein the circumference portions are arranged to lie against the rod;
wherein said circumference portions are formed at least partly by a slider piece of a second material different than the first material which is an insert-molded part of the cradle.

9. The rod cradle of claim 8 wherein the lips edging the rod groove are of the first material.

10. The rod cradle of claim 8, wherein the insert-molded slider piece forms all the circumference portions and also has portions forming a liquid groove contiguous with the rod groove.

11. The rod cradle of claim 8, wherein the slider piece is formed of a polymer.

12. The rod cradle of claim 9 wherein the slider piece is polyurethane.

13. The rod cradle of claim 8 wherein the slider piece is polyurethane filled with a substance that reduces friction.

14. The rod cradle of claim 8, wherein the slider piece is non-homogenous, such that material forming a bottom portion of the rod groove, which bottom portion engages the rod, has a lower coefficient of friction than all other circumference portions.

15. A rod cradle for a film, coating, or sealing rod, comprising:
a first molding having portions forming a base part, portions defining a rod groove, and portions forming a body part which is between the base part and the rod groove, wherein the first molding is formed of a first material; and
a second molding of a second material different than the first material which second molding is an insert-molded part of the rod cradle, wherein the first molding and the second molding are joined permanently to each other, wherein the portions defining a rod groove include circumference portions edging the rod groove, the circumference portions including portions forming lips, the rod groove being arranged to receive a rod between said lips, and wherein the circumference portions are arranged to lie against the rod, and wherein the second molding defines a slider piece which forms at least part of the circumference portions.

16. The rod cradle of claim 15 wherein the lips edging the rod groove are of the first material.

17. The rod cradle of claim 15, wherein the insert-molded slider piece forms all the circumference portions and also has portions forming a liquid groove contiguous with the rod groove.

18. The rod cradle of claim 15, wherein the slider piece is formed of a polymer.

19. The rod cradle of claim 16 wherein the slider piece is polyurethane.

20. The rod cradle of claim 15 wherein the slider piece is polyurethane filled with a substance that reduces friction.

21. The rod cradle of claim 15, wherein the slider piece is non-homogenous, such that material forming a bottom portion of the rod groove, which bottom portion engages the rod, has a lower coefficient of friction than all other circumference portions.
